(19) United States
(12) Patent Application Publication
(10) Pub. No.: US 2023/0345353 A1
(43) Pub. Date: Oct. 26, 2023

(54) METHOD AND APPARATUS FOR OPTIMIZING WIRELESS SERVICE UTILIZATION BY USER EQUIPMENT

(71) Applicant: SAMSUNG ELECTRONICS CO., LTD., Suwon-si (KR)

(72) Inventors: Koustav ROY, Bangalore (IN); Arijit SEN, Bangalore (IN); Danish Ehsan HASHMI, Bangalore (IN); Lalith KUMAR, Bangalore (IN); Sambhavesh HARALALKA, Bangalore (IN)

(73) Assignee: SAMSUNG ELECTRONICS CO., LTD., Suwon-si (KR)

(21) Appl. No.: 18/138,631

(22) Filed: Apr. 24, 2023

Related U.S. Application Data
(63) Continuation of application No. PCT/KR2023/004928, filed on Apr. 12, 2023.

(30) Foreign Application Priority Data
Apr. 24, 2022 (IN) 202241003771
Mar. 28, 2023 (IN) 202241003771

(51) Int. Cl. H04W 60/04; H04W 60/06; H04W 48/18

(52) U.S. Cl. CPC H04W 48/18; H04W 60/04; H04W 60/06; H04W 84/042

(57) ABSTRACT

A method for communication by a UE in a wireless communication system is provided. The method may comprise sending a first request message to access a data service over a first NSSAI and a voice service over a second NSSAI to a first 3GPP RAT of a first PLMN; receiving a first response message indicating a rejection for establishing an internet PDU session with the first 3GPP RAT of the first PLMN; and determining, for accessing the data service or both the data service and the voice service, one of a second 3GPP RAT of the first PLMN, the first 3GPP RAT of a second PLMN, a N3GPP RAT of the second PLMN, or an N3GPP RAT of the first PLMN

### CROSS-REFERENCE TO RELATED APPLICATIONS

This application is a continuation of International Application No. PCT/KR2023/004928 designating the United States, filed on Apr. 12, 2023, in the Korean Intellectual Property Receiving Office and claiming priority to Indian Provisional Patent Application No. 202241003771 filed on Apr. 24, 2022, in the Indian Patent Office, and Indian Complete Patent Application No.: 202241003771 filed on Mar. 28, 2023, in the Indian Patent Office, the disclosures of each of which are incorporated by reference herein in their entireties.

### BACKGROUND

Network Slice Admission Control Function (NSACF) is a wireless network entity that monitors and controls a number of registered User Equipment’s (UEs) per network slice those are subject to Network Slice Admission Control (NSAC). The NSACF is configured with a maximum number of UEs and/or a maximum number of Packet Data Units (PDU) sessions allowed to be served per Single Network Slice Selection Assistance Information (S-NSSAI) subject to the NSAC. The NSACF is also configured with information indicating applicable access type(s) (i.e. 3GPP access type, Non-3GPP access type, or both) for the S-NSSAI.

FIG. 1 is a sequential diagram illustrating a rejection of a NSSAI due to maximum number of UEs reached causing disruption of a service or data stall in a wireless network, according to prior arts. Consider a scenario in which a UE (10) has pre-configured or network configured a NSSAI-1 for an internet service and a NSSAI-2 for an Internet-protocol Multimedia Subsystem (IMS) service. At 11, the UE (10) sends a registration request with a requested NSSAI as the NSSAI-1, the NSSAI-2 to an Access and Mobility Management Function (AMF) (20) of the wireless network. At 12, an AMF (20) interacts with a network function entity (such as NSACF (30) as both the NSSAI-1 and the NSSAI-2 are subjected to the NSACF (30)). At 13, the network function entity (here for example, the NSACF (30)) rejects the NSSAI-1 and allows the NSSAI-2 for the UE (10) as the NSSAI-1 reached maximum number of UE threshold, and the NSACF (30) puts the NSSAI-1 is a rejected NSSAI list. At 14, the AMF (20) sends a registration accept with an allowed NSSAI list: NSSAI-2 and a rejected NSSAI list: NSSAI-1 to the UE (10). At 15, the UE (10) experience permanent data stall while the UE camped on a Fifth-Generation Wireless Network (5G) as there are no NSSAI available for the internet. This prevents the UE (10) to use the internet service in a Fifth-Generation Wireless Network (5G) as there are no other allowed slice available for the internet service. If the network entity function (here, the NSACF (30)) does not provide any back off timer for the NSSAI-1 (as per 3GPP back of timer is optional and left for operator implementation), then the UE (10) may end up having permanent data stall as the NSSAI-1 is in the rejected list and as a result the UE (10) cannot put the rejected NSSAIs in the requested NSSAI list.

FIG. 2 is a sequential diagram illustrating a rejection of a PDU session due to maximum number of PDUs reached causing data stall in the wireless network, according to the prior arts. Consider a scenario in which the UE (10) has pre-configured or network configured the NSSAI-1 for the internet service and the NSSAI-2 for the IMS service. In this case while the UE (10) wants to use internet traffic, the UE (10) try to establish the PDU session for internet with the NSSAI-1 network slice. So at 21, the UE (10) sends a PDU Session establishment with NSSAI-1 to a Session Management Function + Packet Data Network Gateway-Control (SMF+PGW-C) (40) of the wireless network. At 22, the SMF+PGW-C (40) triggers interaction with the NSACF (30) to check the availability of the network slice. At 23, the NSACF (30) rejects the PDU session establishment as maximum number of PDU session reached for the NSSAI-1 with or without back off timer with reject cause as “maximum number of PDU session reached”. At 24, the SMF+PGW-C (40) rejects the PDU session establishment of the UE (10) as maximum number of PDU session reached for NSSAI-1. This prevents the UE (10) to use the internet service in the 5G as there are no other allowed slice available for the internet service. Then, at 25, the UE (10) may end up having permanent data stall as the all PDU session with the NSSAI-1 is rejected.

FIG. 3 is a sequential diagram illustrating a rejection of a Packet Data Network (PDN) connection due to maximum number of PDUs reached and/or maximum number of UEs reached causing data stall in the wireless network, according to the prior arts. A network slice admission control for maximum number of UEs and/or maximum number of PDU sessions per network slice is performed at a time of a PDN connection establishment in case of Evolved Packet Core (EPC) interworking. During the PDN connection establishment in the EPC, the SMF+PGW-C (40) selects the S-NSSAI associated with the PDN connection. If the selected S-NSSAI by the SMF+PGW-C (40) is subject to the NSAC, the SMF+PGW-C (40) triggers interaction with the NSACF (30) to check the availability of the network slice by invoking separate NSAC procedures for number of UE and number of PDU session before the SMF+PGW-C (40) provides the selected S-NSSAI to the UE (10). If the maximum number of UEs and/or the maximum number of PDU sessions has already been reached, unless operator policy implements a different action, the SMF+PGW-C (40) rejects the PDN connection. Now in the scenario while the UE (10) tries to establish the PDN connection for internet and associated NSSAI (e.g. NSSAI-1) is subject to NSAC, the NSACF (30) might reject the PDN connection if maximum number of UE and/or maximum number of PDU sessions has already been reached at the NSACF (30).

At 31, the UE (10) sends a PDN connection request to the SMF+PGW-C (40). At 32 SMF+PGW-C (40) identifies associated NSSAI for the PDN connection (e.g. NSSAI-1) and triggers interaction with the NSACF (30) to check the availability of the network slice. At 33, the NSACF (30) sends maximum number of PDU session reached for the NSSAI-1. At 34, the SMF+PGW-C (40) sends a PDN connection reject as maximum number of PDU session reached for NSSAI-1 with or without back off timer. At 35, the UE (10) experiences the permanent data stall while the UE (10) camps on the Fourth-Generation Wireless Network (4G) as there are no PDN connection active.

FIG. 4 is a sequential diagram illustrating a rejection to establish a new PDU session by the UE due to reaching maximum MBR limit, according to the prior arts. If the UE (10) has maximum MBR set for the NSSAI and already the UE (10) has reached the limit of maximum MBRs, then the UE (10) may not be able to request for the new PDU session in 5G (NR) or PDN Connection in 4G (LTE) and get rejected by SMF+PGW C(40) because of the MBR limit reached.

Consider, the UE (10) is utilizing the NSSAI which is subject to the NSACF (30). At 41, the UE (10) already has x number of PDU session on a network slice NSSAI-1 which reaches the maximum MBR for the slice. At 42, the UE (10) requests for another PDU session on same network slice. At 43, the UE (10) is rejected by the NSACF (30) due to maximum MBR allowed on the network slice NSSAI 1 exceeds. At 44, the UE’s PDU session is disconnected due to reject, and the UE (10) is no longer able to request for another PDU session on same network slice. If the NSSAI is subject to the NSACF (30), the UE (10) is very likely to get reject for the NSSAI in a crowded location such as a stadium, a shopping Mall etc., and to experience the permanent data stall. Thus, it is desired to provide a useful solution for optimizing wireless service utilization of the UE.

### OBJECT

The principal object of the embodiments herein is to provide a system and method for optimizing wireless service utilization by user equipment.

Another object of the embodiments herein is to recover data stall when the UE receives any NSSAI in rejected NSSAI list with or without cause maximum number of UE is reached or with or without cause maximum number of PDU session reached for any NSSAI, by moving the UE to other available RAT(e.g. LTE), or by moving UE to other available access type(e.g. N3GPP Access) and using PDU over the newly found access type or by switching to other available equivalent or lower priority PLMNs to avail both voice and data services, which enhances user experience while UE is connected over the 5GC.

### SUMMARY

According to an aspect of the present disclosure, a method for communication by a user equipment (UE) in a wireless communication system is provided. The method may comprise sending a first request message to access a data service over a first network slice selection assistance information (NSSAI) and a voice service over a second NSSAI to a first 3^{rd} generation partnership project (3GPP) radio access technology (RAT) of a first public land mobile network (PLMN); receiving a first response message indicating a rejection for establishing an internet protocol data unit (PDU) session with the first 3GPP RAT of the first PLMN; and determining, for accessing the data service or both the data service and the voice service, one of a second 3GPP RAT of the first PLMN, the first 3GPP RAT of a second PLMN, a Non-3GPP (N3GPP) RAT of the second PLMN, or an N3GPP RAT of the first PLMN.

The method may also include deregistering, by the UE, from the first 3GPP RAT of the first PLMN upon determining the second 3GPP RAT of the first PLMN, wherein the second 3GPP RAT is equivalent or lower prioritized than the first 3GPP RAT; and registering, by the UE, on the second 3GPP RAT of the first PLMN for accessing the data service or both the data service and the voice service.

The method may also include sending, by the UE, a second request message to access the data service from the first NSSAI to the N3GPP RAT of the second PLMN upon determining the N3GPP RAT of the second PLMN, wherein the second PLMN is equivalent or lower prioritized than the first PLMN, and the UE has access to the 3GPP RAT of the first PLMN and the N3GPP RAT of the second PLMN; receiving, by the UE, a second response message with an allowed NSSAI list includes the first NSSAI; and routing, by the UE, an internet PDU over the first NSSAI of the N3GPP RAT of the second PLMN.

The routing may also include establishing, by the UE, the internet PDU session with the first NSSAI of the N3GPP RAT of the second PLMN; and routing, by the UE, the internet PDU over the first NSSAI of the N3GPP RAT of the second PLMN.

The method may also include routing, by the UE, an internet PDU over the first NSSAI of the N3GPP RAT of the first PLMN upon determining the N3GPP RAT of the first PLMN, wherein the UE has access to both the 3GPP and N3GPP RATs available over the first PLMN, the UE is registered for an N3GPP access over the first NSSAI, and the first NSSAI is in an allowed NSSAI list of the N3GPP access.

The method may also include performing, by the UE, one of: a PLMN search by releasing an N1 signalling connection, wait for the first PLMN to send a detach request and wait for a predefined period of time, wherein the PLMN search is performed by lowering a priority of the first PLMN; finding, by the UE, the second PLMN based on the PLMN search; camping, by the UE, on the second PLMN; and sending, by the UE, Registration request to the second PLMN with the first NSSAI and the second NSSAI for accessing the data service and the voice service respectively.

According to an aspect of the present disclosure, a method for communication by a user equipment (UE) in a wireless communication system is provided. The method may comprise sending a packet data network (PDN) connection request message to a wireless network for establishing a PDN connection over a first NSSAI of a RAT; receiving a PDN connection reject message from the wireless network upon reaching maximum number of PDU session for the first NSSAI; and performing, for accessing a data service or both the data service and a voice service, at least one of: disabling N1 mode and reattaching to an evolved packet core (EPC) of the wireless network, detaching from the EPC and registering over new radio (NR) of the wireless network, or detaching from the EPC and lowering a priority of current PLMN and triggering PLMN selection to other higher priority PLMN.

According to an aspect of the present disclosure, a method for communication by a user equipment (UE) in a wireless communication system is provided. The method may comprise sending a PDU session request message to a wireless network for establishing a new PDU session over a first NSSAI of a RAT; receiving a PDU session reject message from the wireless network upon reaching maximum of maximum bit rate (MBR) for the first NSSAI; and performing for establishing the new PDU session, one of: sending a request message to the wireless network for disconnecting a lowest priority PDU session in the first NSSAI, and modifying an Aggregate Maximum Bit Rate (AMBR) value for Non-Guaranteed Bit Rate (NGBR) bearers in the first NSSAI. This method may also include sending, by the UE, another PDU session request message to the wireless network for establishing the new PDU session over the first NSSAI of the RAT; and storing, by the UE upon receiving an acceptance or a rejection for establishing the new PDU session from the wireless network, application information and PDU session parameters into a database, wherein the application information and PDU session parameters correspond to the lowest priority PDU session.

According to an aspect of the present disclosure, a method for communication by a user equipment (UE) in a wireless communication system is provided. The method may comprise sending a PDU session request message to a wireless network for establishing a new PDU session using a first NSSAI over a 3GPP access of a first PLMN, wherein the UE is registered for both the 3GPP access and a N3GPP access over the first PLMN or a second PLMN and the first NSSAI is in an allowed NSSAI list of both the 3GPP access and the N3GPP access; receiving a PDU session reject message from the wireless network upon reaching maximum of maximum bit rate (MBR) for the first NSSAI; sending another PDU session request message to the wireless network for establishing the new PDU session using the first NSSAI over the N3GPP access of the first PLMN or the second PLMN; and creating the new PDU session using the first NSSAI over the N3GPP access with the wireless network. This method may also include continuing, by the UE, the new PDU session using the first NSSAI over the N3GPP access till releasing an existing PDU session established on the first NSSAI over the 3GPP access of the first PLMN.

According to an aspect of the present disclosure, a method for communication by a user equipment (UE) in a wireless communication system is provided. The method may comprise registering to a wireless network for creating a PDU session; determining a geographical location of the UE based on the registering; determining whether the geographical location is crowded using a machine learning (ML) or deep learning (DL) model; and creating the PDU session in advance upon determining that the geographical location is crowded. This method may also include storing, by the UE, information into a database upon receiving an acceptance or a rejection for creating the PDU session from the wireless network and/or training, by the UE, the ML or DL model to predict a crowded area and identify future PDU session requirement based on user past behavior.

According to an aspect of the present disclosure, a UE is provided. The UE may comprise a memory; at least one processor coupled to the memory. The at least one processor may be configured to send a first request message to access a data service over a first NSSAI and a voice service over a second NSSAI to a first 3GPP RAT of a first PLMN, receive a first response message indicating a rejection with respect to establishing an internet PDU session with the first 3GPP RAT of the first PLMN, and determine one of a second 3GPP RAT of the first PLMN, the first 3GPP RAT of a second PLMN, a first N3GPP RAT of the second PLMN, and a second N3GPP RAT of the first PLMN for accessing the data service or both the data service and the voice service.

According to an aspect of the present disclosure, a UE is provided. The UE may comprise a memory; at least one processor coupled to the memory. The at least one processor may be configured to: send a PDN connection request message to a wireless network for establishing a PDN connection over a first NSSAI of a RAT, receive a PDN connection reject message from the wireless network upon reaching maximum number of PDU session for the first NSSAI, and access a data service or both the data service and a voice service by: disabling N1 mode and reattaching to an evolved packet core (EPC) of the wireless network, detaching from the EPC and registering over new radio (NR) of the wireless network, or detaching from the EPC and lowering a priority of current PLMN and triggering PLMN selection to other higher priority PLMN.

According to an aspect of the present disclosure, a UE is provided. The UE may comprise a memory; at least one processor coupled to the memory. The at least one processor may be configured to: send a PDU session request message to a wireless network for establishing a new PDU session over a first NSSAI of a RAT, receive a PDU session reject message from the wireless network upon reaching maximum of maximum bit rate (MBR) for the first NSSAI, and establish the new PDU session, by: sending a request message to the wireless network for disconnecting a lowest priority PDU session in the first NSSAI, or modifying an aggregate maximum bit rate (AMBR) value for non-guaranteed bit rate (NGBR) bearers in the first NSSAI.

According to an aspect of the present disclosure, a UE is provided. The UE may comprise a memory; at least one processor coupled to the memory. The at least one processor may be configured to: send a PDU session request message to a wireless network for establishing a new PDU session using a first NSSAI over a 3GPP access of a first PLMN, wherein the UE is registered for both the 3GPP access and a N3GPP access over the first PLMN or a second PLMN and the first NSSAI is in an allowed NSSAI list of both the 3GPP access and the N3GPP access, receive a PDU session reject message from the wireless network upon reaching maximum of Maximum Bit Rate (MBR) for the first NSSAI, send another PDU session request message to the wireless network for establishing the new PDU session using the first NSSAI over the N3GPP access of the first PLMN or the second PLMN, or create the new PDU session using the first NSSAI over the N3GPP access with the wireless network.

According to an aspect of the present disclosure, a UE is provided. The UE may comprise a memory; at least one processor coupled to the memory. The at least one processor may be configured to: register to a wireless network for creating a PDU session, thereby determining a geographical location of the UE, determine whether the geographical location is crowded using a machine learning (ML) or deep leaning (DL) model, and create the PDU session in advance upon determining that the geographical location is crowded.

According to an aspect of the present disclosure, a non-transitory computer readable storage medium storing instructions is provided. When the instructions are executed by at least one processor of a UE, the instructions may cause the UE to perform operations. The operations may comprise sending a first request message to access a data service over a first network slice selection assistance information, NSSAI, and a voice service over a second NSSAI to a first 3^{rd} generation partnership project, 3GPP, radio access technology, RAT, of a first public land mobile network, PLMN; receiving a first response message indicating a rejection for establishing an internet protocol data unit, PDU, session with the first 3GPP RAT of the first PLMN; and determining, for accessing the data service or both the data service and the voice service, one of a second 3GPP RAT of the first PLMN, the first 3GPP RAT of a second PLMN, a non-3GPP, N3GPP, RAT of the second PLMN, or an N3GPP RAT of the first PLMN.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a sequential diagram illustrating a rejection of a NSSAI due to maximum number of UEs reached causing disruption of a service or data stall in a wireless network, according to prior arts;

FIG. 2 is a sequential diagram illustrating a rejection of a PDU session due to maximum number of PDUs reached causing disruption of a service or data stall in the wireless network, according to the prior arts;

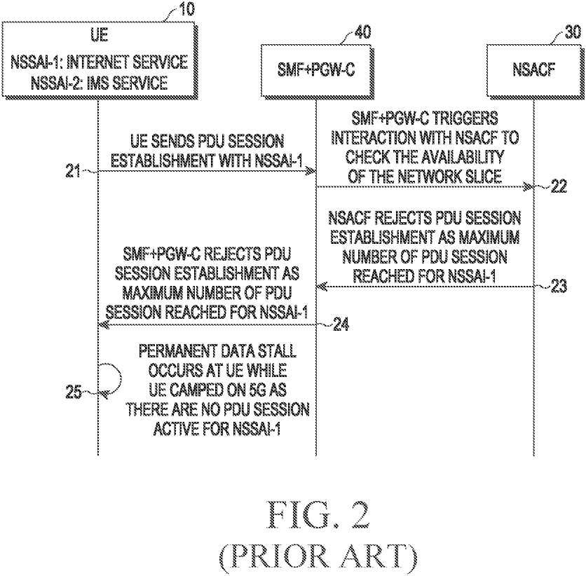

FIG. 3 is a sequential diagram illustrating a rejection of a PDN connection due to maximum number of PDUs reached causing disruption of a service or data stall in the wireless network, according to the prior arts;

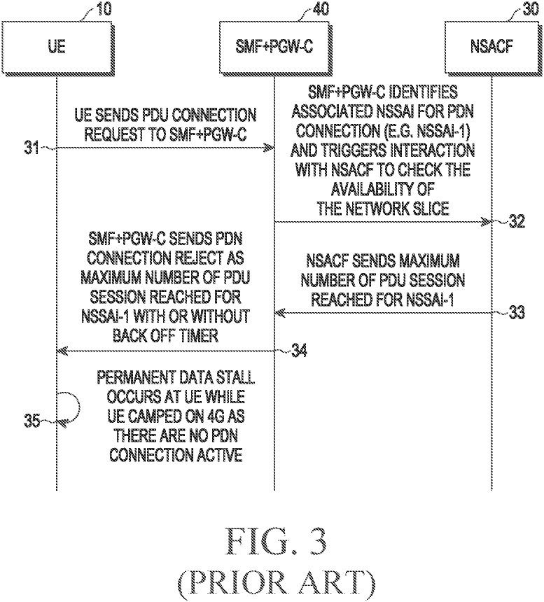

FIG. 4 is a sequential diagram illustrating a rejection to establish a new PDU session by the UE due to reaching maximum MBR limit, according to the prior arts;

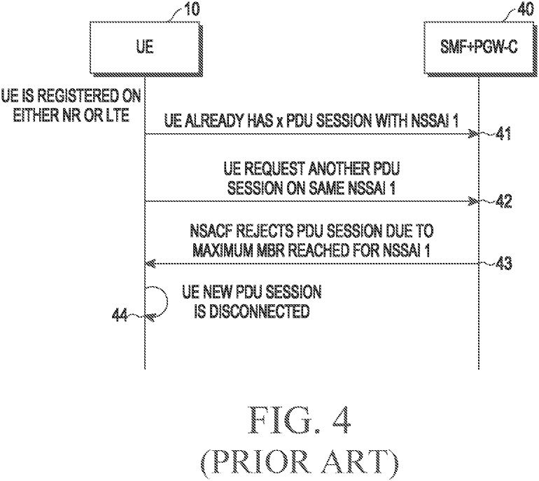

FIG. 5 is a block diagram of a UE for optimizing wireless service utilization, according to an embodiment as disclosed herein;

FIG. 6 is a flow diagram illustrating a method for optimizing the wireless service utilization, according to an embodiment as disclosed herein;

FIG. 7A is a sequential diagram illustrating a method of changing a RAT by the UE to overcome data stall issue in 5G, according to an embodiment as disclosed herein;

FIG. 7B is a sequential diagram illustrating a method of availing the NSSAI over other access type belongs to different PLMN by the UE to overcome the data stall issue in the 5G, according to an embodiment as disclosed herein;

FIG. 7C is a sequential diagram illustrating a method of availing the NSSAI over other access type belongs to same PLMN by the UE to overcome the data stall issue in the 5G, according to an embodiment as disclosed herein;

FIG. 7D is a sequential diagram illustrating a method of the UE evaluating other PLMNs to overcome the data stall issue in the 5G, according to an embodiment as disclosed herein;

FIG. 8A is a sequential diagram illustrating a method of choosing different RAT by the UE to overcome the data stall issue in the 5G, according to embodiment as disclosed herein;

FIG. 8B is a sequential diagram illustrating a method of availing the NSSAI over other access type belongs to different PLMN by the UE to overcome the data stall issue in the 5G, according to embodiment as disclosed herein;

FIG. 8C is a sequential diagram illustrating a method of availing the NSSAI over other access type belongs to same PLMN by the UE to overcome the data stall issue in the 5G, according to embodiment as disclosed herein;

FIG. 8D is a sequential diagram illustrating a method of the UE evaluating other PLMNs to overcome PDU Session rejection causing the data stall issue in the 5G, according to an embodiment as disclosed herein;

FIG. 9A is a sequential diagram illustrating a method of disabling N1 mode and attaching to a EPC by the UE to overcome the data stall issue in the 4G, according to an embodiment as disclosed herein;

FIG. 9B is a sequential diagram illustrating a method of detaching from the EPC and registering over SA by the UE to overcome the data stall issue in the 4G, according to an embodiment as disclosed herein;

FIG. 9C is a sequential diagram illustrating a method of detaching from the EPC and moving to different PLMN by the UE to overcome the data stall issue in the 4G, according to an embodiment as disclosed herein;

FIG. 10A is a sequential diagram illustrating a method of disconnecting lower priority PDU sessions by the UE to overcome the data stall issue in the 5G, according to an embodiment as disclosed herein; and

FIG. 10B is a sequential diagram illustrating a method of intelligently identifying crowded places and establishing PDU session before use by the UE to overcome a future data stall issue in the 5G, according to an embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Throughout this disclosure, the terms “N3GPP” and “non 3GPP” are used interchangeably and mean the same.

As a part of Rel18 a new entity called Network Slice Admission Control Function (NSACF) has been introduced which is responsible to admit a certain number of UEs or certain number of PDU sessions per Network Slice. As per 3GPP this NSACF check is applicable for default Slices as well. With this feature deployed in Network it is possible for a UE to face complete or permanent data stall as there is no method to overcome data stall in 5GC due to cause of internet NSSAI in blacklist or default internet PDU is rejected as per current prior art. Hence the method proposed in this disclosure allows the UE to overcome the data stall while UE is in 5GC.

The proposed method can be used to recover data stall when the UE receives any internet NSSAI in rejected NSSAI list with or without cause maximum number of UEs is reached or when network rejects any internet PDU session establishment with or without cause maximum number of PDU session reached, by moving the UE to other available RAT (e.g. LTE), or by moving UE to other available access type(e.g. N3GPP Access) and using internet PDU over the newly found access type or by switching to other available equivalent or lower priority PLMNs to avail both voice and data services. The proposed method solves the problem of permanent or temporary (based on back off timer) data stall caused due to the NSACF or any other feature at network side which can cause permanent or temporary data stall in the UE while the UE is in 5GC, which enhances user experience while UE is connected over the 5GC.Accordingly, the embodiments herein provide a method for optimizing wireless service utilization by a User Equipment (UE). The method includes sending, by the UE, a first request message to access a data service over a first NSSAI and a voice service over a second NSSAI to a first 3GPP RAT of a first PLMN of a wireless network. The UE is configured with the first NSSAI and the second NSSAI for accessing the data service and the voice service respectively. Further, the method includes receiving, by the UE, a first response message indicates a rejection for establishing an internet PDU from the first 3GPP RAT of the first PLMN. Further, the method includes determining, by the UE, one of a second 3GPP RAT of the first PLMN, the first 3GPP RAT of the second PLMN, a N3GPP RAT of a second PLMN of the wireless network, and a N3GPP RAT of the first PLMN for accessing the data service or both the data service and the voice service.

Accordingly, the embodiments herein provide another method for optimizing wireless service utilization by the UE. The method includes sending, by the UE, a PDN connection request message to a wireless network for establishing a PDN connection over the first NSSAI of a RAT. Further, the method includes receiving, by the UE, a PDN connection reject message from the wireless network upon reaching maximum number of PDU session for the first NSSAI. Further, the method includes performing, by the UE, for accessing the data service or both the data service and the voice service, one of: disabling N1 mode and reattaching to an Evolved Packet Core (EPC) of the wireless network, detaching from the EPC and registering over New Radio (NR) of the wireless network, and detaching from the EPC and lowering a priority of current PLMN and triggering PLMN selection to other higher priority PLMN.

Accordingly, the embodiments herein provide another method for optimizing wireless service utilization by the UE. The method includes sending, by the UE, a PDU session request message to a wireless network for establishing a new PDU session over the first NSSAI of the RAT. Further, the method includes receiving, by the UE, a PDU session reject message from the wireless network upon reaching maximum of Maximum Bit Rate (MBR) for the first NSSAI. Further, the method includes performing, by the UE, for establishing a new PDU session, one of: sending a request message to the wireless network for disconnecting a lowest priority PDU session in the first NSSAI. Further, the method includes modifying an Aggregate Maximum Bit Rate (AMBR) value for Non-Guaranteed Bit Rate (NGBR) bearers in the first NSSAI.

Accordingly, the embodiments herein provide another method for optimizing wireless service utilization by the UE. The method includes sending, by the UE, the PDU session request message to a wireless network for establishing a new PDU session using a first NSSAI over a 3GPP access of a first PLMN. The UE is registered for both the 3GPP access and a N3GPP access over the first PLMN or a second PLMN and the first NSSAI is in the allowed NSSAI list of both the 3GPP access and the N3GPP access. Further, the method includes receiving, by the UE, a PDU session reject message from the wireless network upon reaching maximum of Maximum Bit Rate (MBR) for the first NSSAI. Further, the method includes sending, by the UE, the another PDU session request message to the wireless network for establishing the new PDU session using the first NSSAI over the N3GPP access of the first PLMN or the second PLMN. Further, the method includes creating, by the UE, the new PDU session using the first NSSAI over the N3GPP access with the wireless network.

Accordingly, the embodiments herein provide another method for optimizing wireless service utilization by the UE. The method includes registering, by the UE, to a wireless network for creating a PDU session. Further, the method includes determining, by the UE, a geographical location of the UE based on the registration. The method includes determining, by the UE, whether the geographical location is crowded using a Machine Learning (ML) model. The method includes creating, by the UE, a PDU session in advance upon determining that the geographical location is crowded.

Accordingly, the embodiments herein provide the UE for optimizing wireless service utilization. The UE includes a wireless service optimizer, a memory, a processor, where the wireless service optimizer is coupled to the memory and the processor. The wireless service optimizer is configured for sending the first request message to access the data service over the first NSSAI and the voice service over the second NSSAI to the first 3GPP RAT of the first PLMN of the wireless network. The UE is configured with the first NSSAI and the second NSSAI for accessing the data service and the voice service respectively. The wireless service optimizer is configured for receiving the first response message indicates the rejection for establishing the internet PDU from the first 3GPP RAT of the first PLMN. The wireless service optimizer is configured for determining one of the second 3GPP RAT of the first PLMN, the first 3GPP RAT of the second PLMN, the N3GPP RAT of the second PLMN of the wireless network, and the N3GPP RAT of the first PLMN for accessing the data service or both the data service and the voice service.

Accordingly, the embodiments herein provide the UE for optimizing wireless service utilization. The UE includes the wireless service optimizer, the memory, the processor, where the wireless service optimizer is coupled to the memory and the processor. The wireless service optimizer is configured for sending the PDN connection request message to the wireless network for establishing the PDN connection over the first NSSAI of the RAT. The wireless service optimizer is configured for receiving the PDN connection reject message from the wireless network upon reaching maximum number of PDU session for the first NSSAI. The wireless service optimizer is configured for performing for accessing the data service or both the data service and the voice service, one of: disabling N1 mode and reattaching to the Evolved Packet Core (EPC) of the wireless network, detaching from the EPC and registering over New Radio (NR) of the wireless network, and detaching from the EPC and lowering the priority of current PLMN and triggering PLMN selection to other higher priority PLMN.

Accordingly, the embodiments herein provide the UE for optimizing wireless service utilization. The UE includes the wireless service optimizer, the memory, the processor, where the wireless service optimizer is coupled to the memory and the processor. The wireless service optimizer is configured for sending the PDU session request message to the wireless network for establishing the new PDU session over the first NSSAI of the RAT. The wireless service optimizer is configured for receiving the PDU session reject message from the wireless network upon reaching maximum of Maximum Bit Rate (MBR) for the first NSSAI. The wireless service optimizer is configured for performing for establishing the new PDU session, one of: sending the request message to the wireless network for disconnecting the lowest priority PDU session in the first NSSAI, and modifying the Aggregate Maximum Bit Rate (AMBR) value for Non-Guaranteed Bit Rate (NGBR) bearers in the first NSSAI.

Accordingly, the embodiments herein provide the UE for optimizing wireless service utilization. The UE includes the wireless service optimizer, the memory, the processor, where the wireless service optimizer is coupled to the memory and the processor. The wireless service optimizer is configured for sending the PDU session request message to the wireless network for establishing the new PDU session using the first NSSAI over the 3GPP access of the first PLMN. The UE is registered for both the 3GPP access and the N3GPP access over the first PLMN or the second PLMN and the first NSSAI is in the allowed NSSAI list of both the 3GPP access and the N3GPP access. The wireless service optimizer is configured for receiving the PDU session reject message from the wireless network upon reaching maximum of Maximum Bit Rate (MBR) for the first NSSAI. The wireless service optimizer is configured for sending another PDU session request message to the wireless network for establishing the new PDU session using the first NSSAI over the N3GPP access of the first PLMN or the second PLMN. The wireless service optimizer is configured for creating the new PDU session using the first NSSAI over the N3GPP access with the wireless network.

Accordingly, the embodiments herein provide the UE for optimizing wireless service utilization. The UE includes the wireless service optimizer, the memory, the processor, where the wireless service optimizer is coupled to the memory and the processor. The wireless service optimizer is configured for registering to the wireless network for creating the PDU session. The wireless service optimizer is configured for determining the geographical location of the UE based on the registration. The wireless service optimizer is configured for determining whether the geographical location is crowded using the Machine Learning (ML) model. The wireless service optimizer is configured for creating the PDU session in advance upon determining that the geographical location is crowded.

In one embodiment if network rejects the PDU session for a particular NSSAI due to the NSACF feature or any other network feature and if the rejection of NSSAI may cause data stall for one or all application or disruption of service for all or some applications, then the UE chooses to de-register over 5G and try accessing the services over 4G RAT. In embodiment if the network rejects the PDU session establishment of the particular NSSAI due to the NSACF feature and if the NSSAI may cause data stall for one or all application or disruption of service for all or some applications, then the UE chooses to utilise the NSSAI or equivalent NSSAI over other Access type of different PLMN if available. In embodiment if the network rejects the PDU session of the particular NSSAI due to the NSACF feature and if the NSSAI may cause data stall for one or all application or disruption of service for all or some applications, then the UE chooses to utilise the NSSAI or equivalent NSSAI over other access type of same PLMN if available.

In an embodiment, if the network rejects the PDN connection request due to the NSACF feature and if the PDN connection unavailability may cause data stall or IMS service unavailability for one or all application or disruption of service for all or some applications, then the UE chooses to disable N1 mode and reattaches to the LTE RAT to overcome NSACF check (as without N1 mode no associated NSSAI is present for PDN connection). In embodiment if the network rejects the PDN connection request due to the NSACF feature or any other network feature and if the PDN connection unavailability may cause data stall or IMS service unavailability for one or all application or disruption of service for all or some applications, then the UE chooses to detach from the LTE RAT and registers over a NR RAT. In embodiment if network rejects PDN connection request due to NSACF feature or any other network feature and if the PDN connection unavailability may cause data stall or IMS service unavailability for one or all application or disruption of service for all or some applications, then the UE may choose to detach from the LTE RAT, lower the priority of current PLMN and trigger higher priority PLMN search to avail the all required services.

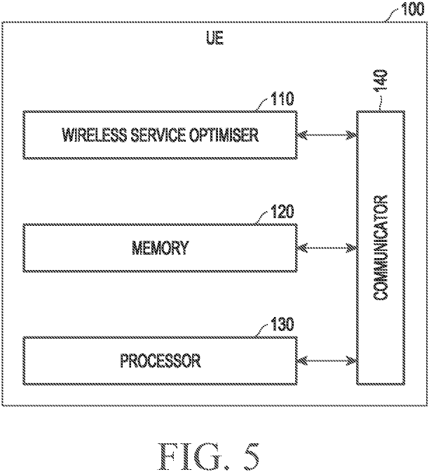

Referring now to the drawings, and more particularly to FIGS. 5 through 10B, there are shown preferred embodiments.

FIG. 5 is a block diagram of the UE (100) for optimizing wireless service utilization, according to an embodiment as disclosed herein. Examples of the UE (100) include, but are not limited to a smartphone, a tablet computer, a Personal Digital Assistance (PDA), a desktop computer, an Internet of Things (IoT), a wearable device, etc. In an embodiment, the UE (100) includes a wireless service optimizer (110), a memory (120), a processor (130), a communicator (140), and an optional Machine Learning (ML) or Deep Learning (DL) model (not shown). The wireless service optimizer (110) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like. The wireless service optimizer (110) and the processor (130) may be integrally referred to as at least one processor. The wireless service optimizer has a function of improving the wireless service experienced at the UE.

The communicator 140 may be implemented with RF components and circuitry along with logic gates, hardware processors and memories for performing wireless communication functions.

In an embodiment, the wireless service optimizer (110) sends a first request message to access a data service over a first Network Slice Selection Assistance Information (NSSAI) and a voice service over a second NSSAI to a first 3rd Generation Partnership Project (3GPP) Radio Access Technology (RAT) (e.g. gNodeB) of a first Public Land Mobile Network (PLMN) of a wireless network, where the UE (100) is configured with the first NSSAI and the second NSSAI for accessing the data service and the voice service respectively. Further, the wireless service optimizer (110) receives a first response message indicates a rejection for establishing an internet Packet Data Unit (PDU) from the first 3GPP RAT of the first PLMN. Further, the wireless service optimizer (110) determines one of a second 3GPP RAT of the first PLMN, the first 3GPP RAT of the second PLMN, a Non-3rd Generation Partnership Project (N3GPP) RAT (e.g. Wi-Fi) of a second PLMN of the wireless network, and a N3GPP RAT of the first PLMN for accessing the data service or both the data service and the voice service.

In an embodiment, the wireless service optimizer (110) deregisters from the first 3GPP RAT of the first PLMN upon determining the second 3GPP RAT of the first PLMN, where the second 3GPP RAT is equivalent or lower prioritized than the first 3GPP RAT. Further, the wireless service optimizer (110) registers on the second 3GPP RAT of the first PLMN for accessing the data service or both the data service and the voice service.

In an embodiment, the wireless service optimizer (110) sends a second request message to access the data service from the first NSSAI to the N3GPP RAT of the second PLMN upon determining the N3GPP RAT of the second PLMN, where the second PLMN is equivalent or lower prioritized than the first PLMN, and the UE (100) has access to the 3GPP RAT of the first PLMN and the N3GPP RAT of the second PLMN. Further, the wireless service optimizer (110) receives a second response message with an allowed NSSAI list includes the first NSSAI. Further, the wireless service optimizer (110) routes the internet PDU over the first NSSAI of the N3GPP RAT of the second PLMN.

In an embodiment, for routing the internet PDU over the first NSSAI of the N3GPP RAT of the second PLMN, the wireless service optimizer (110) establishes an internet PDU session with the first NSSAI of the N3GPP RAT of the second PLMN. Further, the wireless service optimizer (110) routes the internet PDU over the first NSSAI of the N3GPP RAT of the second PLMN.

In an embodiment, the wireless service optimizer (110) routes the internet PDU over the first NSSAI of the N3GPP RAT of the first PLMN upon determining the N3GPP RAT of the first PLMN, where the UE (100) has access to both the 3GPP and N3GPP RATs available over the first PLMN, the UE (100) is registered for an N3GPP access over the first NSSAI, and the first NSSAI is in an allowed NSSAI list of the N3GPP access.

In an embodiment, the wireless service optimizer (110) deregisters from the first 3GPP RAT of the first PLMN upon determining the first 3GPP RAT of the second PLMN, where the second PLMN is equivalent or lower prioritized than the first PLMN. Further, the wireless service optimizer (110) registers on the first 3GPP RAT of the second PLMN for accessing the data service or both the data service and the voice service.

In embodiment, the wireless service optimizer (110) sends a Packet Data Network (PDN) connection request message to the wireless network for establishing a PDN connection over a first NSSAI of the 3GPP RAT. Further, the wireless service optimizer (110) receives a PDN connection reject message from the wireless network upon reaching maximum number of PDU session for the first NSSAI. In an embodiment, the wireless service optimizer (110) disables N1 mode and reattaches to an Evolved Packet Core (EPC) of the wireless network for accessing the data service or both the data service and the voice service. In embodiment, the wireless service optimizer (110) detaches from the EPC and registers over a New Radio (NR) of the wireless network for accessing the data service or both the data service and the voice service. In embodiment, the wireless service optimizer (110) detaches from the EPC and lowers a priority of current PLMN and triggers PLMN selection to other higher priority PLMN for accessing the data service or both the data service and the voice service.

In embodiment, the wireless service optimizer (110) sends a PDU session request message to the wireless network for establishing a new PDU session over the first NSSAI of the 3GPP RAT. Further, the wireless service optimizer (110) receives a PDU session reject message from the wireless network upon reaching maximum of Maximum Bit Rate (MBR) for the first NSSAI. In an embodiment, the wireless service optimizer (110) sends a request message to the wireless network for disconnecting a lowest priority PDU session in the first NSSAI for establishing a new PDU session. In embodiment, the wireless service optimizer (110) modifies an Aggregate Maximum Bit Rate (AMBR) value for Non-Guaranteed Bit Rate (NGBR) bearers in the first NSSAI. In an embodiment, the wireless service optimizer (110) sends another PDU session request message to the wireless network for establishing the new PDU session over the first NSSAI of the RAT. Further, the wireless service optimizer (110) stores application information (e.g. application identifier, operating system identifier etc.),) and PDU session parameters (e.g. Session and Service Continuity (SSC) Mode, PDU type etc.)) that helps the UE (100) to identify the lowest priority PDU session into a database upon receiving an acceptance or a rejection for establishing the new PDU session from the wireless network.

In embodiment, the wireless service optimizer (110) sends the PDU session request message to a wireless network for establishing a new PDU session using a first NSSAI over a 3GPP access of a first PLMN. The UE (100) is registered for both the 3GPP access and a N3GPP access over the first PLMN or a second PLMN and the first NSSAI is in an allowed NSSAI list of both the 3GPP access and the N3GPP access. Further, the wireless service optimizer (110) receives a PDU session reject message from the wireless network upon reaching maximum of Maximum Bit Rate (MBR) for the first NSSAI. Further, the wireless service optimizer (110) sends another PDU session request message to the wireless network for establishing the new PDU session using the first NSSAI over the N3GPP access of the first PLMN or the second PLMN. Further, the wireless service optimizer (110) creates the new PDU session using the first NSSAI over the N3GPP access with the wireless network.

In an embodiment, the wireless service optimizer (110) continues the new PDU session using the first NSSAI over the N3GPP access till releasing an existing PDU session established on the first NSSAI over the 3GPP access of the first PLMN.

In embodiment, the wireless service optimizer (110) registers to the wireless network for creating the PDU session. Further, the wireless service optimizer (110) determines a geographical location of the UE (100) based on the registration. Further, the wireless service optimizer (110) determines whether the geographical location is crowded using a Machine Learning (ML) or Deep Learning (DL) model. Further, the wireless service optimizer (110) creates the PDU session in advance upon determining that the geographical location is crowded. The wireless service optimizer (110) stores the application information and the PDU session parameters into the database upon receiving an acceptance or a rejection for creating the PDU session from the wireless network. The wireless service optimizer (110) trains the ML or DL model to predict a crowded area and identifies future PDU session requirement based on user past behavior.

The memory (120) stores instructions to be executed by the processor (130). The memory (120) contains the database to store information of the NSSAI, the Access Type, the RAT, the Accept/Reject, the PDU Session Count, the MBR, the PDU session, and the PDU session priority. The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information than its storage space. In certain examples, a non-transitory storage medium may store data that can, over time, change (e.g., in Random Access Memory (RAM) or cache). The memory (120) can be an internal storage unit or it can be an external storage unit of the UE (100), a cloud storage, or any other type of external storage.

The processor (130) is configured to execute instructions stored in the memory (120). The processor (130) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (130) may include multiple cores to execute the instructions. The communicator (140) is configured for communicating internally between hardware components in the UE (100). Further, the communicator (140) is configured to facilitate the communication between the UE (100) and other devices via one or more networks (e.g. Radio technology). The communicator (140) includes an electronic circuit specific to a standard that enables wired or wireless communication.

A function associated with the ML or DL model may be performed through the non-volatile/volatile memory (120), and the processor (130). The one or a plurality of processors (130) control the processing of the input data in accordance with a predefined operating rule or the ML or DL model stored in the non-volatile/volatile memory (120). The predefined operating rule or the ML or DL model is provided through training or learning. Here, being provided through learning means that, by applying a learning method to a plurality of learning data, the predefined operating rule or the ML or DL model of a desired characteristic is made. The learning may be performed in the electronic device (100) itself in which the ML or DL model according to an embodiment is performed, and/or may be implemented through a separate server/system. The DL model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. The learning method is a method for training a predetermined target device (for example, a robot) using a plurality of learning data to cause, allow, or control the target device to make a determination or prediction. Examples of the learning method include, but are not limited to, supervised learning, unsupervised learning, semi-supervised learning, or reinforcement learning.

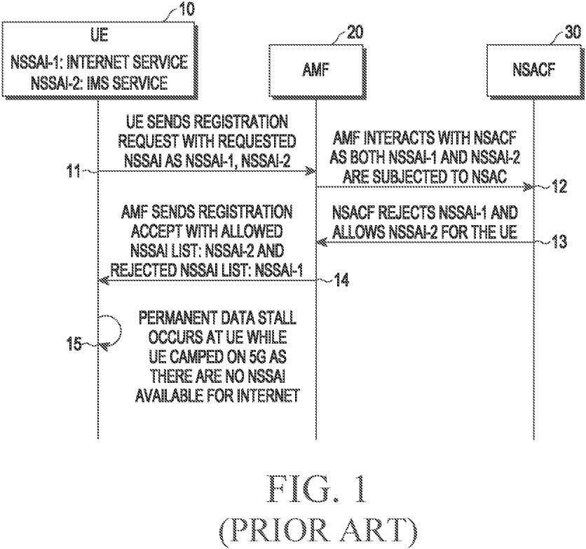

Although the FIG. 1 shows the hardware components of the UE (100) but it is to be understood that other embodiments are not limited thereon. In other embodiments, the UE (100) may include less or a greater number of components. Further, the labels or names of the components are used only for illustrative purpose and does not limit the scope of the invention. One or more components can be combined together to perform same or substantially similar function for optimizing the wireless service utilization

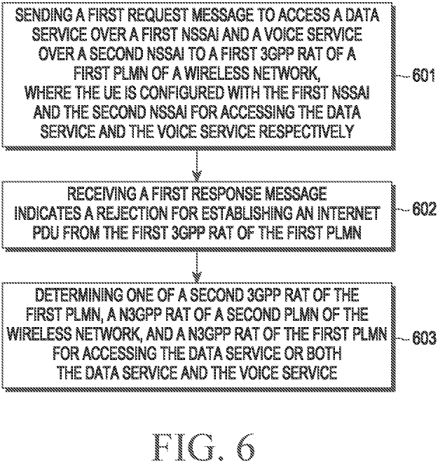

FIG. 6 is a flow diagram (600) illustrating a method for optimizing the wireless service utilization, according to an embodiment as disclosed herein. In an embodiment, the method allows the wireless service optimizer (110) to perform operations 601-603 of the flow diagram (600). At operation 601, the method includes sending the first request message to access the data service over the first NSSAI and the voice service over the second NSSAI to the first 3GPP RAT of the first PLMN of the wireless network, where the UE (100) is configured with the first NSSAI and the second NSSAI for accessing the data service and the voice service respectively. At operation 602, the method includes receiving the first response message indicates the rejection for establishing the internet PDU from the first 3GPP RAT of the first PLMN. At operation 603, the method includes determining one of the second 3GPP RAT of the first PLMN, the N3GPP RAT of the second PLMN of the wireless network, and the N3GPP RAT of the first PLMN for accessing the data service or both the data service and the voice service.

The various actions, acts, blocks, operations, or the like in the flow diagram (600) may be performed in the order presented, in a different order, or simultaneously. Further, in some embodiments, some of the actions, acts, blocks, operations, or the like may be omitted, added, modified, skipped, or the like without departing from the scope of the invention.

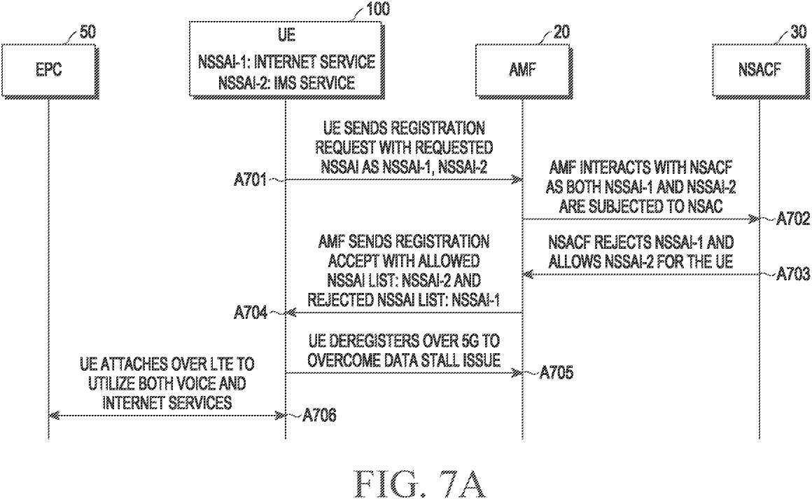

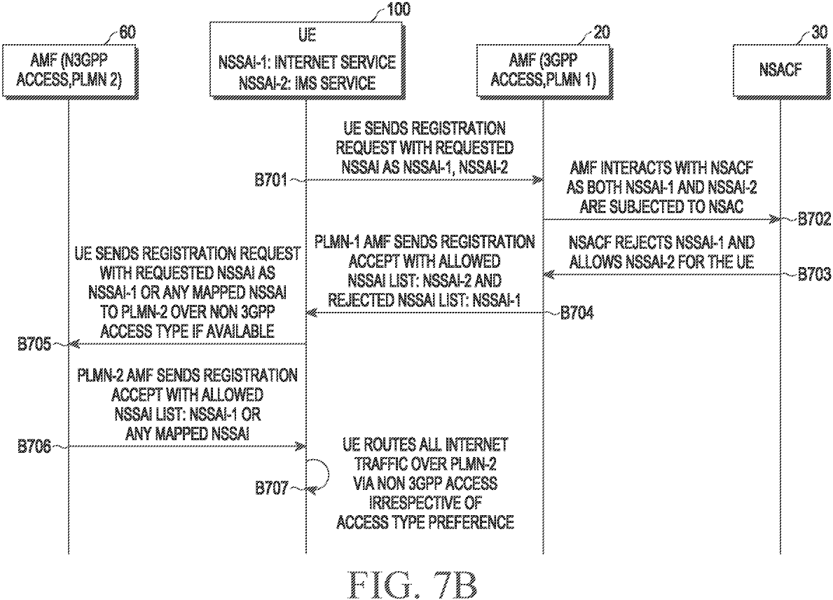

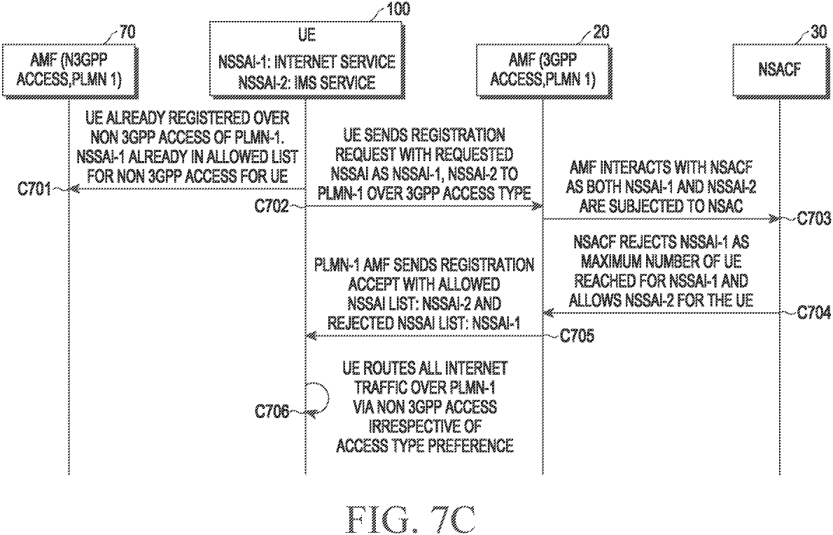

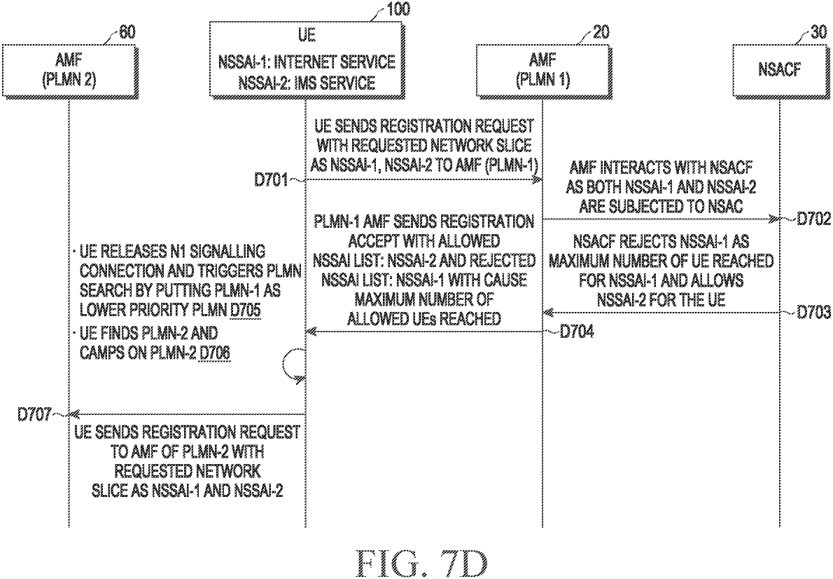

FIG. 7A is a sequential diagram illustrating a method of changing a RAT by the UE (100) to overcome data stall issue in 5G, according to an embodiment as disclosed herein. Consider a scenario in which the UE (100) has pre-configured or the wireless network configured a NSSAI-1 for an internet service and a NSSAI-2 for an Internet-protocol Multimedia Subsystem (IMS) service.

At A701, the UE (100) sends a registration request (i.e. first request message) with a requested NSSAI as NSSAI-1, NSSAI-2 to the Access and Mobility Management Function (AMF) (20) of the wireless network. At A702, the AMF (20) interacts with the NSACF (30) as both NSSAI-1 and NSSAI-2 are subjected to the NSACF (30). At A703, the NSACF (30) rejects the NSSAI-1 and allows the NSSAI-2 for the UE (100) as the NSSAI-1 reached maximum number of UE threshold, and the NSACF (30) puts the NSSAI-1 is a rejected NSSAI list. At A704, the AMF (20) sends a registration accept (i.e. first response message) with an allowed NSSAI list: NSSAI-2 and a rejected NSSAI list: NSSAI-1 to the UE (100). At A705, the UE (100) deregisters over the 5G RAT to overcome the data stall issue. At A706, the UE (100) attaches over the LTE RAT (i.e. EPC (50)) to utilize both the voice and internet services.

FIG. 7B is a sequential diagram illustrating a method of availing the NSSAI over other access type belongs to different PLMN by the UE (100) to overcome the data stall issue in the 5G, according to an embodiment as disclosed herein. Consider a scenario in which the UE (100) has pre-configured or the wireless network configured the NSSAI-1 for the internet service and the NSSAI-2 for the IMS service. The UE (100) has both 3GPP Access type and N3GPP Access type available over different PLMNs, i.e. the 3GPP Access type over a PLMN-1, and the non-3GPP Access type over a PLMN-2.

At B701, the UE (100) sends the registration request (i.e. first request message) with the requested NSSAI as NSSAI-1, NSSAI-2 to the AMF (20) of the PLMN-1 with 3GPP access. At B702, the AMF (20) interacts with the NSACF (30) as both NSSAI-1 and NSSAI-2 are subjected to the NSACF (30). At B703, the NSACF (30) rejects the NSSAI-1 and allows the NSSAI-2 for the UE (100) as the NSSAI-1 reached maximum number of the UE threshold, and the NSACF (30) puts the NSSAI-1 is the rejected NSSAI list. At B704, the AMF (20) sends the registration accept (i.e. first response message) with the allowed NSSAI list: NSSAI-2 and the rejected NSSAI list: NSSAI-1 to the UE (100).

At B705, the UE (100) sends a registration request (i.e. second request message) with the requested NSSAI as the NSSAI-1 or any mapped NSSAI to the PLMN-2 over the non-3GPP access type if available to avoid the data stall issue. At B706, the PLMN-2 AMF (60) sends the registration accept (i.e. second response message) with the allowed NSSAI list : NSSAI-1 or any mapped NSSAI. At B707, the UE (100) routes all internet traffic over the PLMN-2 via non-3GPP access irrespective of access type preference.

FIG. 7C is a sequential diagram illustrating a method of availing the NSSAI over other access type belongs to same PLMN by the UE (100) to overcome the data stall issue in the 5G, according to an embodiment as disclosed herein. Consider a scenario in which the UE (100) has pre-configured or the wireless network configured the NSSAI-1 for the internet service and the NSSAI-2 for the IMS service. The UE (100) has both 3GPP Access type and N3GPP Access type available over same PLMN, i.e. PLMN-1. At C701, the UE (100) is already registered over the non-3GPP access and NSSAI-1 is in allowed list of N3GPP Access type.

At C702, the UE (100) sends the registration request (i.e. first request message) with the requested NSSAI as NSSAI-1, NSSAI-2 to the AMF (20) of the PLMN-1 with 3GPP access. At C703, the AMF (20) interacts with the NSACF (30) as both NSSAI-1 and NSSAI-2 are subjected to the NSACF (30). At C704, the NSACF (30) rejects the NSSAI-1 and allows the NSSAI-2 for the UE (100) as the NSSAI-1 reached maximum number of the UE threshold, and the NSACF (30) puts the NSSAI-1 is the rejected NSSAI list. At C705, the AMF (20) sends the registration accept (i.e. first response message) with the allowed NSSAI list: NSSAI-2 and the rejected NSSAI list: NSSAI-1 to the UE (100). At C706, the UE (100) routes all internet traffic over the PLMN-1 via the non-3GPP access irrespective of access type preference to avoid the data stall issue.

FIG. 7D is a sequential diagram illustrating a method of the UE (100) evaluating other PLMNs to overcome the data stall issue in the 5G, according to an embodiment as disclosed herein. Consider a scenario in which the UE (100) has pre-configured or the wireless network configured the NSSAI-1 for the internet service and the NSSAI-2 for the IMS service.

At D701, the UE (100) sends the registration request with the requested NSSAI as NSSAI-1, NSSAI-2 to the AMF (20) of the PLMN-1. At D702, the AMF (20) interacts with the NSACF (30) as both NSSAI-1 and NSSAI-2 are subjected to the NSACF (30). At D703, the NSACF (30) rejects the NSSAI-1 and allows the NSSAI-2 for the UE (100) as the NSSAI-1 reached maximum number of the UE threshold, and the NSACF (30) puts the NSSAI-1 is the rejected NSSAI list. At D704, the AMF (20) sends the registration accept with the allowed NSSAI list: NSSAI-2 and the rejected NSSAI list: NSSAI-1 to the UE (100). At D705, the UE (100) releases N1 Signalling connection and triggers the PLMN search by putting the PLMN-1 as lower priority PLMN and at D706 the UE (100) finds the PLMN-2 and camps on the PLMN-2. At D707, the UE (100) sends Registration request to the AMF (60) of the PLMN-2 with requested Network Slice as the NSSAI-1 and the NSSAI-2.

Therefore, if the network rejects a particular Network Slice and if the Network Slice may cause data stall for one or all application or disruption of service for all or some applications, the UE (100) may choose to perform PLMN selection procedure by optionally putting current PLMN as lower priority if current serving PLMN is not HPLMN/EHPLMN optionally after a predefined timer or immediately after the reject received.

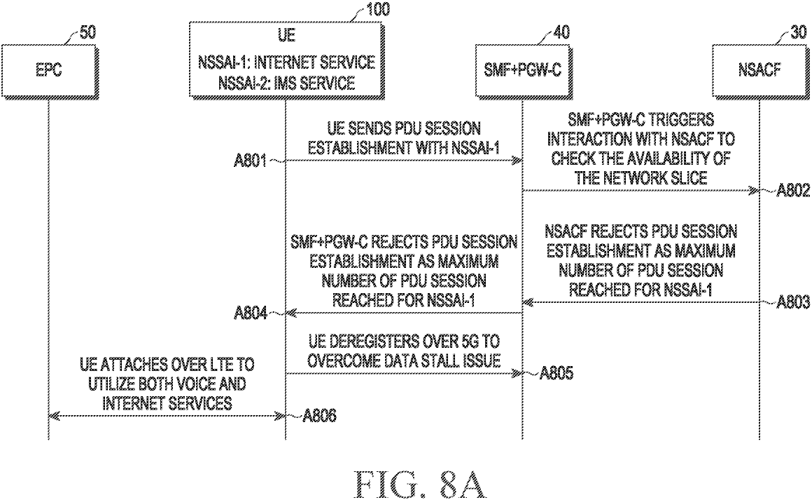

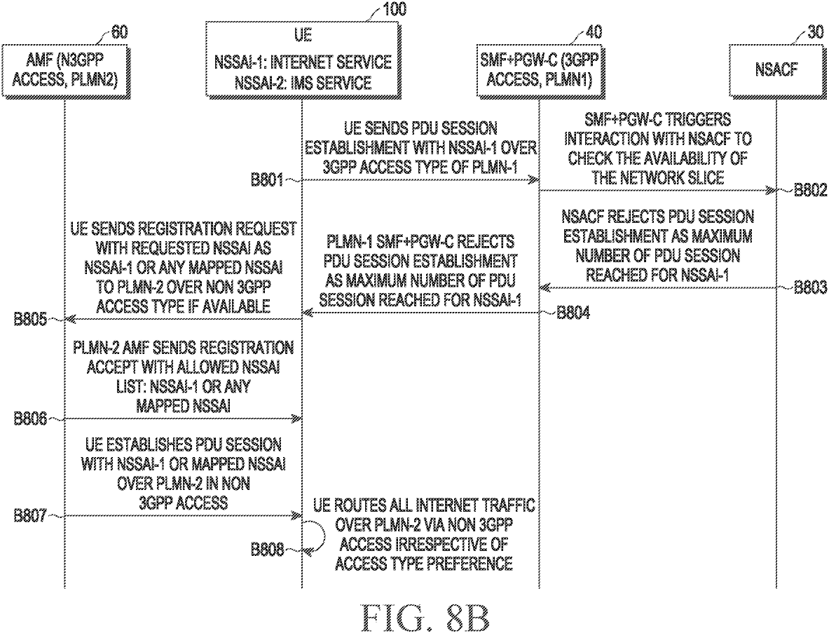

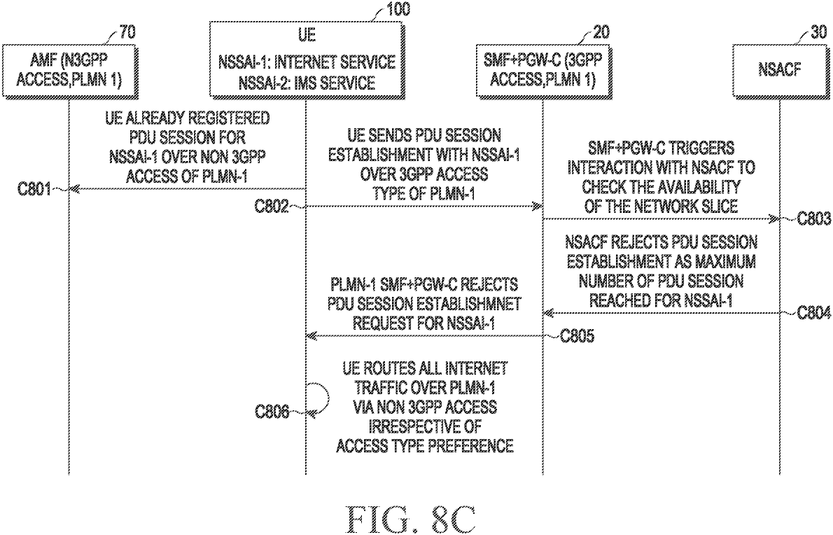

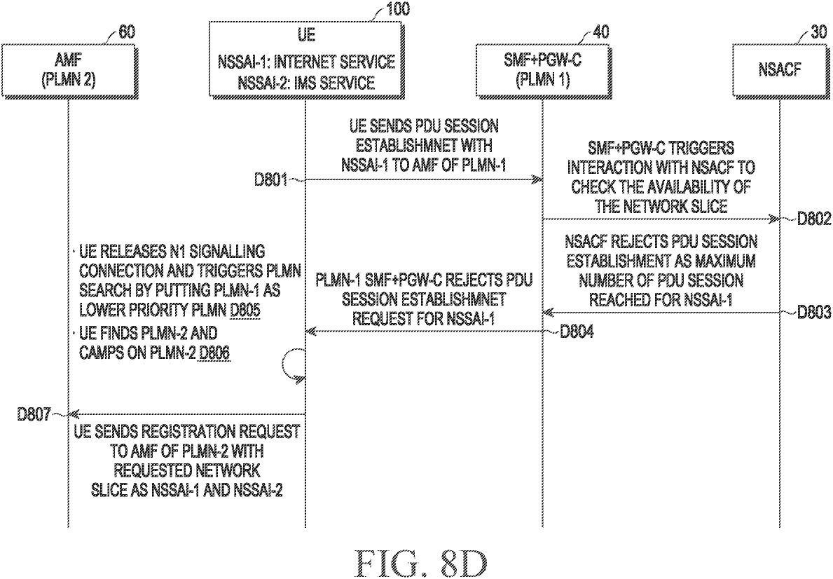

FIG. 8A is a sequential diagram illustrating a method of choosing different RAT by the UE (100) to overcome the data stall issue in the 5G, according to embodiment as disclosed herein. Consider a scenario in which the UE (100) has pre-configured or the wireless network configured the NSSAI-1 for the internet service and the NSSAI-2 for the IMS service.

At A801, the UE (100) sends the registration request (i.e. first request message) to the SMF+PGW-C (40) for the PDU session establishment with the NSSAI-1. At A802, the SMF+PGW-C (40) triggers interaction with the NSACF (30) to check the availability of the network slice. At A803, the NSACF (30) rejects the PDU session establishment as maximum number of PDU session reached for the NSSAI-1. At A804, the SMF+PGW-C (40) rejects the registration request (i.e. first response message) of the UE (100) as maximum number of PDU session reached for the NSSAI-1. At A805, the UE (100) deregisters over the 5G RAT to overcome the data stall issue. At A806, the UE (100) attaches over the LTE RAT (i.e. the EPC (50)) to utilize both the voice and internet services.

FIG. 8B is a sequential diagram illustrating a method of availing the NSSAI over other access type belongs to different PLMN by the UE (100) to overcome the data stall issue in the 5G, according to embodiment as disclosed herein. Consider a scenario in which the UE (100) has pre-configured or the wireless network configured the NSSAI-1 for the internet service and the NSSAI-2 for the IMS service. The UE (100) has both 3GPP Access type and N3GPP Access type available over different PLMNs, i.e. the 3GPP Access type over a PLMN-1, and the non-3GPP Access type over a PLMN-2.

At B801, the UE (100) sends the registration request (i.e. first request message) to the SMF+PGW-C (40) of the PLMN-1 with 3GPP access for the PDU session establishment with the NSSAI-1. At B802, the SMF+PGW-C (40) triggers interaction with the NSACF (30) to check the availability of the network slice. At B803, the NSACF (30) rejects the PDU session establishment as maximum number of PDU session reached for the NSSAI-1. At B804, the SMF+PGW-C (40) rejects the registration request of the UE (100) as maximum number of PDU session reached for the NSSAI-1.

At B805, the UE (100) sends another registration request with the requested NSSAI as the NSSAI-1 or any mapped NSSAI to the PLMN-2 over the non-3GPP access type if available to avoid the data stall issue. At B806, the PLMN-2 AMF (60) sends another registration accept with the allowed NSSAI list : NSSAI-1 or any mapped NSSAI. At B807, the UE (100) establishes the PDU Session with the NSSAI-1 or the mapped NSSAI over the PLMN-2 in the non-3GPP access. At B808, the UE (100) routes all internet traffic over the PLMN-2 via non-3GPP access irrespective of access type preference.

FIG. 8C is a sequential diagram illustrating a method of availing the NSSAI over other access type belongs to same PLMN by the UE (100) to overcome the data stall issue in the 5G, according to embodiment as disclosed herein. Consider a scenario in which the UE (100) has pre-configured or the wireless network configured the NSSAI-1 for the internet service and the NSSAI-2 for the IMS service. The UE (100) has both 3GPP Access type and N3GPP Access type available over same PLMN, i.e. PLMN-1. At C801, the UE

(100) is already established a PDU Session for the NSSAI-1 over the non-3GPP access of the PLMN-1.

At C802, the UE (100) sends the registration request (i.e. first request message) to the SMF+PGW-C (40) of the PLMN-1 with 3GPP access for the PDU session establishment with the NSSAI-1. At C803, the SMF+PGW-C (40) triggers interaction with the NSACF (30) to check the availability of the network slice. At C804, the NSACF (30) rejects the PDU session establishment as maximum number of PDU session reached for the NSSAI-1. At C805, the SMF+PGW-C (40) rejects the registration request of the UE (100) as maximum number of PDU session reached for the NSSAI-1. At C806, the UE (100) routes all internet traffic over the PLMN-1 via the non-3GPP access irrespective of access type preference to avoid the data stall issue.

FIG. 8D is a sequential diagram illustrating a method of the UE (100) evaluating other PLMNs to overcome PDU Session rejection causing the data stall issue in the 5G, according to an embodiment as disclosed herein. Consider a scenario in which the UE

(100) has pre-configured or the wireless network configured the NSSAI-1 for the internet service and the NSSAI-2 for the IMS service.

At D801, the UE (100) sends the PDU session establishment with the NSSAI-1 to the AMF (20) of the PLMN-1. At D802, the SMF+PGW-C (40) triggers interaction with the NSACF (30) to check the availability of the network slice. At D803, the NSACF (30) rejects the PDU Session establishment as maximum number of PDU session reached for the NSSAI-1 and at D804 the PLMN-1 SMF+PGW-C (40) rejects the PDU Session establishment request for the NSSAI-1. Further, at D805, the UE (100) releases the N1 Signalling connection and triggers the PLMN search by putting the PLMN-1 as lower priority PLMN. At D806, the UE (100) finds the PLMN-2 and camps on the PLMN-2. At D807, the UE (100) sends Registration request to the AMF (60) of the PLMN-2 with requested Network Slice as the NSSAI-1 and the NSSAI-2.

Therefore, if the network rejects the PDU Session of a particular Network Slice due to the NSACF feature and if the Network Slice may cause data stall for one or all application or disruption of service for all or some applications, the UE (100) may choose to perform the PLMN search by locally releasing N1 signalling connection or wait for Network to release the connection or wait for some predefined or configured time. As an example, the wait for a release may mean waiting for the PLMN-1 to send a detach request and wait for a predefined period of time. The UE (100) optionally may lower the current PLMN priority before starting of PLMN search. The UE (100) may avoid the proposed solution in case serving PLMN is HPLMN or EHPLMN.

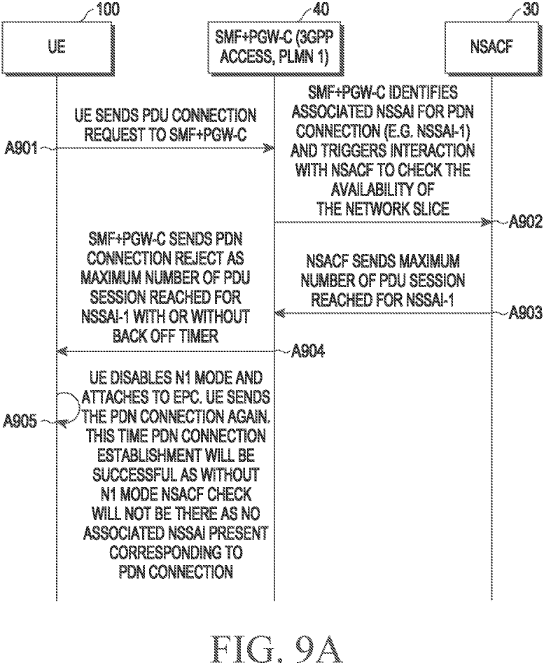

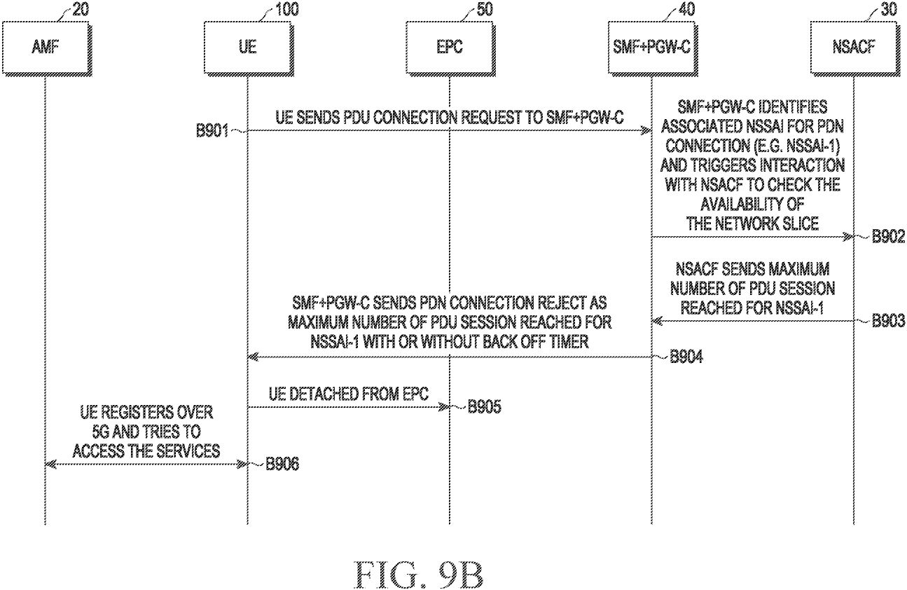

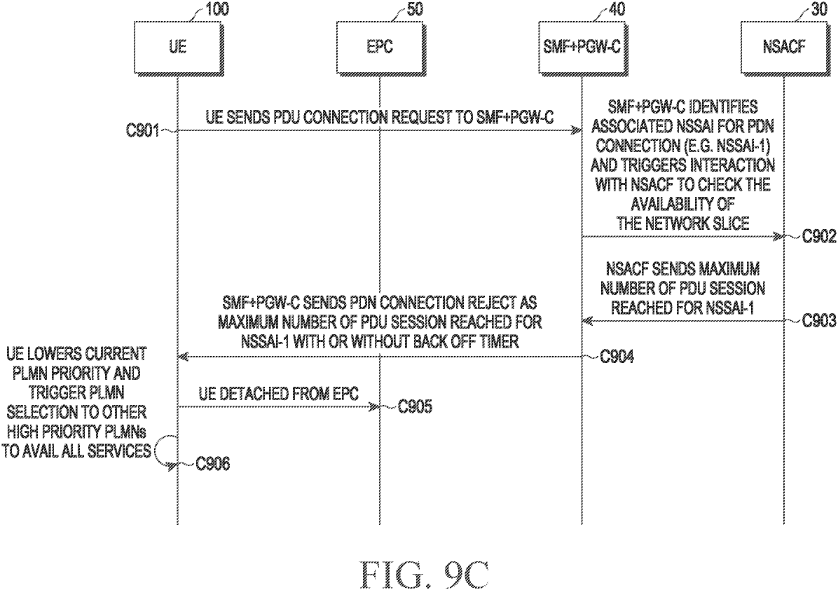

FIG. 9A is a sequential diagram illustrating a method of disabling N1 mode and attaching to the EPC (50) by the UE (100) to overcome the data stall issue in the 5G, according to an embodiment as disclosed herein. At A901, the UE (100) sends the PDN connection request (i.e. PDN connection request message) to the SMF+PGW-C (40). At A902, the SMF+PGW-C (40) identifies associated NSSAI for PDN connection (e.g. NSSAI-1) and triggers interaction with the NSACF (30) to check the availability of the network slice. At A903, the NSACF (30) sends maximum number of PDU session reached for the NSSAI-1. At A904, the SMF+PGW-C (40) sends the PDN connection reject (i.e. PDN connection reject message) as maximum number of PDU session reached for the NSSAI-1 with or without back off timer. At A905, the UE (100) disables the N1 mode and attaches to the EPC (50) to avoid the data stall issue. Further, the UE (100) sends the PDN connection again, in which the time PDN connection establishment is successful for this time as without N1 mode NSACF check is not there as no associated NSSAI present corresponding to the PDN connection.

FIG. 9B is a sequential diagram illustrating a method of detaching from the EPC (50) and registering over Stand-Alone (SA) by the UE (100) to overcome the data stall issue in the 5G, according to an embodiment as disclosed herein. At B901, the UE (100) sends the PDN connection request to the SMF+PGW-C (40). At B902, the SMF+PGW-C (40) identifies associated NSSAI for PDN connection (e.g. NSSAI-1) and triggers interaction with the NSACF (30) to check the availability of the network slice. At B903, the NSACF (30) sends maximum number of PDU session reached for the NSSAI-1. At B904, the SMF+PGW-C (40) sends the PDN connection reject as maximum number of PDU session reached for the NSSAI-1 with or without back off timer. At B905, the UE (100) detaches from the EPC (50). At B906, the UE (100) registers over the 5G RAT and tries to access all services.

FIG. 9C is a sequential diagram illustrating a method of detaching from the EPC (50) and moving to different PLMN by the UE (100) to overcome the data stall issue in the 5G, according to an embodiment as disclosed herein. At C901, the UE (100) sends the PDN connection request to the SMF+PGW-C (40). At C902, the SMF+PGW-C (40) identifies associated NSSAI for PDN connection (e.g. NSSAI-1) and triggers interaction with the NSACF (30) to check the availability of the network slice. At C903, the NSACF (30) sends maximum number of PDU session reached for the NSSAI-1. At C904, the SMF+PGW-C (40) sends the PDN connection reject as maximum number of PDU session reached for the NSSAI-1 with or without back off timer. At C905, the UE (100) detaches from the EPC (50). At C906, the UE (100) lowers current PLMN priority and triggers PLMN selection to other high priority PLMNs to avail all services.

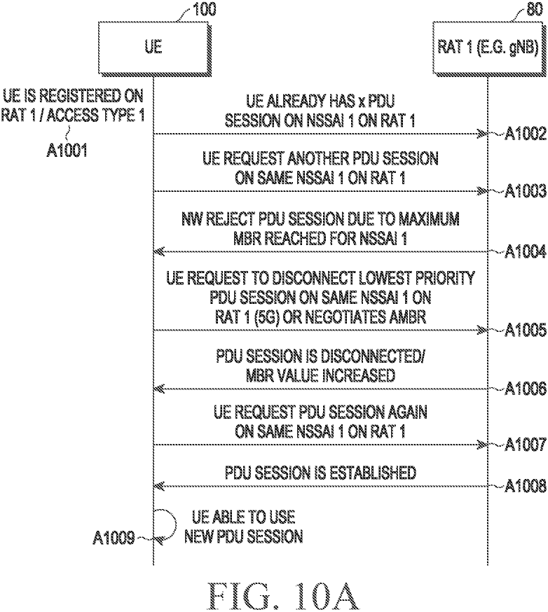

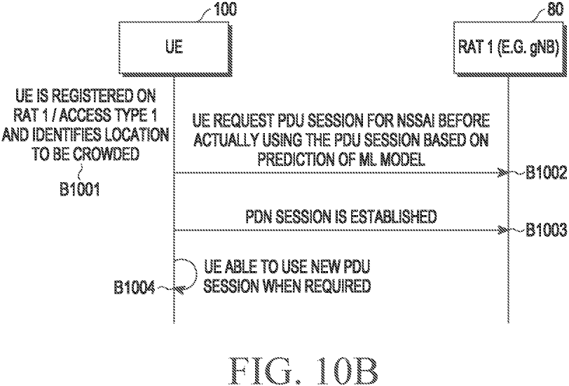

FIG. 10A is a sequential diagram illustrating a method of disconnecting lower priority PDU sessions by the UE (100) to overcome the data stall issue in the 5G, according to an embodiment as disclosed herein. Consider at A1001, the UE (100) is registered on RAT 1 or Access Type 1 (80). At A1002, the UE (100) already has x number of PDU session on a network slice NSSAI-1 of the RAT 1 (80) which reaches the maximum MBR for the slice. At A1003, the UE (100) requests for another PDU session on same network slice NSSAI-1. At A1004 43, the UE (100) is rejected on the RAT 1 (80) due to maximum MBR allowed on the network slice NSSAI-1 exceeds. At A1005, the UE (100) requests to the RAT 1 (80) to disconnect lowest priority PDU session for the NSSAI 1 or, the UE (100) negotiates AMBR value (for non GBR bearers) using the same network slice NSSAI-1. At A1006, the RAT (80) disconnects the PDU session or increases the MBR value. At A1007, the UE (100) requests for the new PDU session on the same network slice NSSAI-1. At A1008-A1009, if the PDU session for the network slice NSSAI-1 is accepted on the RAT 1 (80), then the UE (100) stores the info into the database. When the PDU session for network slice NSSAI-1 is rejected on the RAT 1 (80), then the UE (100) stores the info into the database.

Consider a scenario in which the UE (100) is registered over both 3GPP and N3GPP access types over same or different PLMN(s). Also, the NSSAI-1 or mapped equivalent NSSAI is in allowed list of both the 3GPP access type and the non-3GPP access type. Consider, the UE (100) requests a new PDU session on the same network slice (i.e. NSSAI-1) over the 3GPP Access of the PLMN-1, and the PLMN-1 SMF+PGW-C (40) rejects the PDU session establishment over the 3GPP access due to maximum MBR reached for the NSSAI-1. Then the UE (100) requests for the PDU session establishment for the NSSAI-1 over the non-3GPP access for the PLMN-2 (or PLMN-1 based on availability of non-3GPP access). Further, the network establishes the PDU session establishment request over the non-3GPP access for NSSAI-1. Further, the UE (100) continues using the non-3GPP access for the new PDU session establishment until any PDU session released over the 3GPP Access over the PLMN-1 for the NSSAI-1.

FIG. 10B is a sequential diagram illustrating a method of intelligently identifying crowded places and establishing PDU session before use by the UE (100) to overcome a future data stall issue in the 5G, according to an embodiment as disclosed herein. At B1001, the UE (100) is registered on the RAT 1 / Access Type 1 (80) and identifies a location (Stadium, Shopping Mall etc.) to be crowded and the PDU session that might be requested by the UE (100) using the ML or DL model based on the user past behavior. At B1002, the UE (100) requests for the PDU session for the NSSAI before actually using the PDU session based on the prediction of the ML or DL model for better assurance of service. At B1003, the RAT 1 (80) establishes the PDN session, and the UE (100) stores the info into the database. At B1004, the UE (100) is able to use new PDU session when required. If the PDU session for the network slice (i.e. NSSAI-1) is rejected on the RAT 1, then also the UE (100) stores the info into the database.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method for communication by a user equipment (UE) in a wireless communication system, the method comprising:
sending a first request message to access a data service over a first network slice selection assistance information (NSSAI) and a voice service over a second NSSAI to a first 3^{rd} generation partnership project (3GPP) radio access technology (RAT) of a first public land mobile network (PLMN);
receiving a first response message indicating a rejection for establishing an internet protocol data unit (PDU) session with the first 3GPP RAT of the first PLMN; and
determining, for accessing the data service or both the data service and the voice service, one of a second 3GPP RAT of the first PLMN, the first 3GPP RAT of a second PLMN, a non-3GPP (N3GPP) RAT of the second PLMN, or an N3GPP RAT of the first PLMN.

2. The method of claim 1, further comprising:
deregistering from the first 3GPP RAT of the first PLMN upon determining the second 3GPP RAT of the first PLMN, wherein the second 3GPP RAT is equivalent or lower prioritized than the first 3GPP RAT; and
registering on the second 3GPP RAT of the first PLMN for accessing the data service or both the data service and the voice service.

3. The method of claim 1, further comprising:
sending a second request message to access the data service from the first NSSAI to the N3GPP RAT of the second PLMN upon determining the N3GPP RAT of the second PLMN, wherein the second PLMN is equivalent or lower prioritized than the first PLMN, and the UE has access to the 3GPP RAT of the first PLMN and the N3GPP RAT of the second PLMN;
receiving a second response message with an allowed NSSAI list includes the first NSSAI; and
routing an internet PDU over the first NSSAI of the N3GPP RAT of the second PLMN.

4. The method of claim 3, wherein the routing comprises:
establishing the internet PDU session with the first NSSAI of the N3GPP RAT of the second PLMN; and
routing the internet PDU over the first NSSAI of the N3GPP RAT of the second PLMN.

5. The method of claim 1, further comprising routing an internet PDU over the first NSSAI of the N3GPP RAT of the first PLMN upon determining the N3GPP RAT of the first PLMN, wherein the UE has access to both the 3GPP and N3GPP RATs available over the first PLMN, the UE is registered for an N3GPP access over the first NSSAI, and the first NSSAI is in an allowed NSSAI list of the N3GPP access.

6. The method of claim 1, further comprising:
performing one of: a PLMN search by releasing an N1 signalling connection, wait for the first PLMN to send a detach request and wait for a predefined period of time, wherein the PLMN search is performed by lowering a priority of the first PLMN;
finding the second PLMN based on the PLMN search;
camping on the second PLMN; and
sending registration request to the second PLMN with the first NSSAI and the second NSSAI for accessing the data service and the voice service respectively.

7. A user equipment (UE) comprising:
a memory; and
at least one processor coupled to the memory, wherein the at least one proessor is configured to:
send a first request message to access a data service over a first network slice selection assistance information (NSSAI) and a voice service over a second NSSAI to a first 3^{rd} generation partnership project (3GPP) radio access technology (RAT) of a first PLMN,
receive a first response message indicating a rejection with respect to establishing an internet protocol data unit (PDU) session with the first 3GPP RAT of the first PLMN, and
determining one of a second 3GPP RAT of the first PLMN, the first 3GPP RAT of a second PLMN, a first N3GPP RAT of the second PLMN, and a second non-3GPP (N3GPP) RAT of the first PLMN for accessing the data service or both the data service and the voice service.

8. The UE of claim 7, wherein the at least one processor is further configured to:
deregister from the first 3GPP RAT of the first PLMN upon determining the second 3GPP RAT of the first PLMN, wherein the second 3GPP RAT is equivalent or lower prioritized than the first 3GPP RAT; and
register on the second 3GPP RAT of the first PLMN for accessing the data service or both the data service and the voice service.

9. The UE of claim 7, wherein the at least one processor is further configured to:
send a second request message to access the data service from the first NSSAI to the N3GPP RAT of the second PLMN upon determining the N3GPP RAT of the second PLMN, wherein the second PLMN is equivalent or lower prioritized than the first PLMN, and the UE has access to the 3GPP RAT of the first PLMN and the N3GPP RAT of the second PLMN;
receive a second response message with an allowed NSSAI list includes the first NSSAI; and
route an internet PDU over the first NSSAI of the N3GPP RAT of the second PLMN.

10. The UE of claim 9, wherein for the routing, the at least one processor is configured to:
establish the internet PDU session with the first NSSAI of the N3GPP RAT of the second PLMN; and
route the internet PDU over the first NSSAI of the N3GPP RAT of the second PLMN.

11. The UE of claim 7, wherein the at least one processor is further configured to route an internet PDU over the first NSSAI of the N3GPP RAT of the first PLMN upon determining the N3GPP RAT of the first PLMN, wherein the UE has access to both the 3GPP and N3GPP RATs available over the first PLMN, the UE is registered for an N3GPP access over the first NSSAI, and the first NSSAI is in an allowed NSSAI list of the N3GPP access.

12. The UE of claim 7, wherein the at least one processor is further configured to:
perform one of: a PLMN search by releasing an N1 signalling connection, wait for the first PLMN to send a detach request and wait for a predefined period of time, wherein the PLMN search is performed by lowering a priority of the first PLMN;
find the second PLMN based on the PLMN search;
camp on the second PLMN; and
send registration request to the second PLMN with the first NSSAI and the second NSSAI for accessing the data service and the voice service respectively.

13. A non-transitory computer readable storage medium storing instructions, which, when executed by at least one processor of a user equipment (UE) causes the UE to perform operations, the operations comprising:
sending a first request message to access a data service over a first network slice selection assistance information (NSSAI) and a voice service over a second NSSAI to a first 3^{rd} generation partnership project (3GPP) radio access technology (RAT) of a first public land mobile network (PLMN);
receiving a first response message indicating a rejection for establishing an internet protocol data unit (PDU) session with the first 3GPP RAT of the first PLMN; and
determining, for accessing the data service or both the data service and the voice service, one of a second 3GPP RAT of the first PLMN, the first 3GPP RAT of a second PLMN, a non-3GPP (N3GPP) RAT of the second PLMN, or an N3GPP RAT of the first PLMN.

14. The non-transitory computer readable storage medium of claim 13, wherein the operations further comprises:
deregistering from the first 3GPP RAT of the first PLMN upon determining the second 3GPP RAT of the first PLMN, wherein the second 3GPP RAT is equivalent or lower prioritized than the first 3GPP RAT; and
registering on the second 3GPP RAT of the first PLMN for accessing the data service or both the data service and the voice service.

15. The non-transitory computer readable storage medium of claim 13, wherein the operations further comprises:
sending a second request message to access the data service from the first NSSAI to the N3GPP RAT of the second PLMN upon determining the N3GPP RAT of the second PLMN, wherein the second PLMN is equivalent or lower prioritized than the first PLMN, and the UE has access to the 3GPP RAT of the first PLMN and the N3GPP RAT of the second PLMN;
receiving a second response message with an allowed NSSAI list includes the first NSSAI; and
routing an internet PDU over the first NSSAI of the N3GPP RAT of the second PLMN.

16. The non-transitory computer readable storage medium of claim 15, wherein the routing comprises:
establishing the internet PDU session with the first NSSAI of the N3GPP RAT of the second PLMN; and
routing the internet PDU over the first NSSAI of the N3GPP RAT of the second PLMN.

17. The non-transitory computer readable storage medium of claim 13, wherein the operations further comprises routing an internet PDU over the first NSSAI of the N3GPP RAT of the first PLMN upon determining the N3GPP RAT of the first PLMN, wherein the UE has access to both the 3GPP and N3GPP RATs available over the first PLMN, the UE is registered for an N3GPP access over the first NSSAI, and the first NSSAI is in an allowed NSSAI list of the N3GPP access.

18. The non-transitory computer readable storage medium of claim 13, wherein the operations further comprises:
performing one of: a PLMN search by releasing an N1 signalling connection, wait for the first PLMN to send a detach request and wait for a predefined period of time, wherein the PLMN search is performed by lowering a priority of the first PLMN;
finding the second PLMN based on the PLMN search;
camping on the second PLMN; and
sending registration request to the second PLMN with the first NSSAI and the second NSSAI for accessing the data service and the voice service respectively.
